(19) United States
(12) Patent Application Publication
(10) Pub. No.: US 2021/0206699 A1
(43) Pub. Date: Jul. 8, 2021

(54) PREPARATION METHOD FOR PLANT GROWTH AGENT FOR ECOLOGICAL WATER RETENTION, FERTILIZER SAVING AND PRODUCTION INCREASE PROMOTION

(71) Applicant: Northeastern University, Shenyang, Liaoning (CN)

(72) Inventors: Lianwei YANG, Shenyang, Liaoning (CN); Ruijie WANG, Shenyang, Liaoning (CN)

(21) Appl. No.: 17/056,371

(22) PCT Filed: Dec. 4, 2018
(86) PCT No.: PCT/CN2018/119114

§ 371 Date: Nov. 17, 2020

(30) Foreign Application Priority Data
Nov. 16, 2018 (CN) 201811362703.3

(51) Int. Cl. C05G 3/80; C05D 9/00

(52) U.S. Cl. CPC C05G 3/80; C05D 9/00

(57) ABSTRACT

A preparation method for a plant growth agent for ecological water retention, fertilizer saving and production increase promotion is disclosed. The contents of various components in the growth agent by mass ratio are: straw 40-72 wt %, polyacrylate 5-12 wt %, diatomaceous earth 6-15 wt %, waste paper 1-5 wt %, zeolite 8-30 wt %, water 10-30 wt %, and additive 0.054-0.135 wt %. The growth agent is prepared by a microwave method. When applied into the soil, the growth agent can quickly absorb and keep rainwater or irrigation water without leakage, thereby ensuring sufficient water in rhizosphere and slow release for use by plants. At the same time, the growth agent has the functions of adsorbing fertilizers such as nitrogen, phosphorus and potassium and retaining the fertilizers in the growth agent for use by plants, thus the loss of nutrients is greatly reduced, and the fertilizer effect is prolonged.

### TECHNICAL FIELD

The present invention belongs to the field of agriculture and forestry, and relates to a preparation method for a plant growth agent for ecological water retention, fertilizer saving and production increase promotion.

### BACKGROUND

Water and nutrients are indispensable in plant growth and development. Water and nutrient deficits have become restrictive factors for the sustainable development of agriculture in our country. At present, China is a country with the highest amount of chemical fertilizer application in the world, but the utilization rate of chemical fertilizers is only about 30%, as most of the chemical fertilizers are lost, and the resource, environment, ecology and other problems caused thereby have become increasingly prominent, which causes an adverse effect on the sustainable development of agriculture. In recent years, the problems of declining groundwater level, land desertification, salinization, water pollution and environmental degradation have occurred in company in China. In the face of the deepening water resource crisis, agricultural water-saving irrigation and the reduction and efficient use of chemical fertilizers have become a general trend. Although some farmland water-saving agents or water-retaining agents have been developed, the agents have the problems such as high cost, poor salt tolerance and potential secondary pollution. The water-retaining agents have the advantages of better water absorption and water retention, but the water-retaining agents with a large water absorption capacity can easily absorb the water in plants, causing an adverse effect on the growth of the plants. In addition, the cost of the existing water-retaining agents is very high, and the fertilizer retaining performance is not good. In view of the above problems, the present invention develops a preparation method for a plant growth agent with the functions of ecological water retention, fertilizer saving and production increase promotion.

### SUMMARY

The present invention discloses a preparation method for a plant growth agent for ecological water retention, fertilizer saving and production increase promotion. After being added to ordinary soil or sandy soil, the plant growth agent absorbs water and expands, which can prevent water leakage or volatilization, and will not absorb the water in plants. In addition, after being added to the soil, the growth agent can absorb fertilizers and slowly release fertilizers for use by plants, thus the loss of water and nutrients can be reduced, and the healthy growth of the plants can be promoted.

The present invention has the following specific technical solution:

A preparation method for a plant growth agent with the functions of ecological water retention, fertilizer saving and production increase promotion, comprising the following steps:

Step 1, preparing various components of raw materials by mass ratio:

Straw 40-72 wt %, polyacrylate 5-12 wt %, diatomite 6-15 wt %, waste paper 1-5 wt %; zeolite 8-30 wt %, water 10-30 wt %, and additive 0.054-0.135 wt %; the additive is a mixture of N—N methylene bisacrylamide, ammonium persulfate, zinc sulfate and sodium dodecylsulphate prepared by a mass ratio of 3:1:10:0.02;

Step 2, crushing the straw to a particle size of 50-120 meshes, and crushing the waste paper to a particle size of 50-100 meshes;

Step 3, mixing the raw materials and preparing by a microwave method with a microwave heating power of 1000-1800 W and a reaction time of 2-10 minutes.

Further, the added amount of the additive is 0.90% times the mass of the added diatomite.

Further, the straw includes one or both of corn straw and rice straw.

Further, the polyacrylate is one or more of sodium polyacrylate, ammonium polyacrylate or potassium polyacrylate.

Further, the waste paper includes one or both of waste newspapers and waste printing paper.

Further, the water is ordinary tap water or deionized water.

Further, the particle size of the zeolite is 30-50 meshes.

The present invention has the following beneficial effects: the growth agent in the soil can quickly absorb and keep rainwater or irrigation water without leakage, thereby ensuring sufficient water in rhizosphere and slow release for use by plants. The growth agent has the functions of adsorbing fertilizers such as nitrogen, phosphorus and potassium and retaining the fertilizers in the growth agent for use by plants, thus the loss of nutrients is greatly reduced, and the fertilizer effect is prolonged. Abundant water and nutrients, as well as additives, can not only improve the soil, but also promote the rapid and healthy growth of plants. In addition, the preparation process of the growth agent is simple, the cost is not high, and the growth agent is non-toxic and harmless. The unique characteristics of the growth agent, such as water absorption, water storage and water retention, play an important role in ecological environment improvement as well as wind break and sand fixation projects; therefore, the growth agent can be widely used in the fields such as land desertification improvement and management, agricultural and forest crop planting, and landscaping.

### DETAILED DESCRIPTION

### Embodiment 1

Raw materials (42 kg of 50-mesh straw, 10 kg of potassium polyacrylate, 8 kg of diatomite, 4 kg of 100-mesh waste newspapers, and 0.072 kg of additive) are put into a steel reactor, added with 10 kg of water, and stirred evenly; after two minutes, 26 kg of 30-mesh zeolite is added, and heated by microwave for 5 minutes with a heating power of 1300 W; and then the yield is taken out and dried to obtain the product of the present invention.

### Embodiment 2

Raw materials (50 kg of 70-mesh straw, 8 kg of ammonium polyacrylate, 6 kg of diatomite, 2 kg of 50-mesh waste printing paper, and 0.054 kg of additive) are put into a steel reactor, added with 14 kg of water, and stirred evenly; after two minutes, 20 kg of 40-mesh zeolite is added, and heated by microwave for 8 minutes with a heating power of 1200 W; and then the yield is taken out and dried to obtain the product of the present invention.

### Embodiment 3

Raw materials (40 kg of 60-mesh straw, 10 kg of ammonium polyacrylate, 9 kg of diatomite, 3 kg of 60-mesh waste newspapers, and 0.081 kg of additive) are put into a steel reactor, added with 16 kg of water, and stirred evenly; after two minutes, 22 kg of 30-mesh zeolite is added, and heated by microwave for 6 minutes with a heating power of 1600 W; and then the yield is taken out and dried to obtain the product of the present invention.

### Embodiment 4

Raw materials (56 kg of 100-mesh straw, 5 kg of potassium polyacrylate, 12 kg of diatomite, 2 kg of 80-mesh waste newspapers, and 0.108 kg of additive) are put into a steel reactor, added with 17 kg of water, and stirred evenly; after two minutes, 8 kg of 50-mesh zeolite is added, and heated by microwave for 4 minutes with a heating power of 1800 W; and then the yield is taken out and dried to obtain the product of the present invention.

1. A preparation method for a plant growth agent with the functions of ecological water retention, fertilizer saving and production increase promotion, comprising the following steps:
step 1, preparing various components of raw materials by mass ratio:
straw 40-72 wt %, polyacrylate 5-12 wt %, diatomite 6-15 wt %, waste paper 1-5 wt %; zeolite 8-30 wt %, water 10-30 wt %, and additive 0.054-0.135 wt %; the additive is a mixture of N—N methylene bisacrylamide, ammonium persulfate, zinc sulfate and sodium dodecylsulphate prepared by a mass ratio of 3:1:10:0.02;
step 2, crushing the straw to a particle size of 50-120 meshes, and crushing the waste paper to a particle size of 50-100 meshes;
step 3, mixing the raw materials and preparing by a microwave method with a microwave heating power of 1000-1800 W and a reaction time of 2-10 minutes.

2. The preparation method for the plant growth agent according to claim 1, wherein the added amount of the additive is 0.90% times the mass of the added diatomite.

3. The preparation method for the plant growth agent according to claim 1, wherein the straw includes one or both of corn straw and rice straw.

4. The preparation method for the plant growth agent according to claim 1, wherein the polyacrylate is one or more of sodium polyacrylate, ammonium polyacrylate or potassium polyacrylate.

5. The preparation method for the plant growth agent according to claim 3, wherein the polyacrylate is one or more of sodium polyacrylate, ammonium polyacrylate or potassium polyacrylate.

6. The preparation method for the plant growth agent according to claim 1, wherein the waste paper includes one or both of waste newspapers and waste printing paper.

7. The preparation method for the plant growth agent according to claim 1, wherein the water is ordinary tap water or deionized water.

8. The preparation method for the plant growth agent according to claim 1, wherein the particle size of the zeolite is 30-50 meshes.
